(19) United States
(12) Patent Application Publication
(10) Pub. No.: US 2025/0278381 A1
(43) Pub. Date: Sep. 4, 2025

(54) METHOD, APPARATUS AND DEVICE FOR DETERMINING SLOT OF FIELD REPLACEABLE UNIT DEVICE

(71) Applicant: SUZHOU METABRAIN INTELLIGENT TECHNOLOGY CO., LTD., Suzhou, Jiangsu (CN)

(72) Inventor: Shuaihao ZHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/858,683

(22) PCT Filed: Jun. 20, 2023
(86) PCT No.: PCT/CN2023/101511

§ 371 Date: Oct. 21, 2024

(30) Foreign Application Priority Data
Nov. 30, 2022 (CN) 202211518297.1

(51) Int. Cl. G06F 13/42

(52) U.S. Cl. CPC G06F 13/4221; G06F 2213/0026

(57) ABSTRACT

The disclosure discloses a method, apparatus and device for determining a slot of a field replaceable unit device, and a nonvolatile readable storage medium, and belongs to the field of computer devices. The method is configured to locate a slot of a field replaceable unit in a computer device. In consideration of the facts that peripheral component interconnect express topologies of different models of computer devices vary, and in a computer device that has a definite peripheral component interconnect express topology, slots of field replaceable unit devices have fixed correspondence relations with peripheral component interconnect express cable numbers, a set of programs is preset in the disclosure, and includes first correspondence relations between peripheral component interconnect express cable numbers and slot numbers of different models of computer devices. In this way, a slot may be quickly and accurately determined through this set of programs when field replaceable units of various types of computer device give a fault alarm, and user experience is improved accordingly.

### CROSS-REFERENCE TO RELATED APPLICATION

The present application is a National Stage Application of PCT International Application No.: PCT/CN2023/101511 filed on Jun. 20, 2023, which claims priority to Chinese Patent Application 202211518297.1 filed in the China National Intellectual Property Administration on Nov. 30, 2022, the disclosure of which is incorporated herein by reference in its entirety.

### TECHNICAL FIELD

The disclosure relates to the field of computer devices, in particular to a method for determining a slot of a field replaceable unit device, and further relates to an apparatus and device for determining a slot of a field replaceable unit (FRU) device, and a computer-readable nonvolatile storage medium.

### BACKGROUND

A field replaceable unit (FRU) device is a common component of a computer device. It will be replaced in the case of a fault alarm in response to that the computer device operates at a customer site. Before the FRU device is replaced, it needs to be located, but its slot is difficult to locate since the computer device is equipped with numerous slots and slots of different types of computers vary dramatically in design. In the related art, a mature method for determining a slot of an FRU device is still unavailable, and poor user experience is caused since slots cannot be located exactly in many cases.

### SUMMARY

An objective of the disclosure is to provide a method for determining a slot of a field replaceable unit device. A set of programs is preset in the disclosure, and includes a first correspondence relation between peripheral component interconnect express cable numbers and slot numbers of different models of computer devices. Another objective of the disclosure is to provide an apparatus and device for determining a slot of a field replaceable unit device, and a computer-readable nonvolatile storage medium. A set of programs is preset in the disclosure, and includes a first correspondence relation between peripheral component interconnect express cable numbers and slot numbers of different models of computer devices.

In order to solve the technical problem, the embodiments of the disclosure provide a method for determining a slot of a field replaceable unit device. The method includes:
obtaining a model of a computer device and a peripheral component interconnect express cable number of a field replaceable unit device in response to that the field replaceable unit device of a peripheral component interconnect express bus of the computer device gives a fault alarm;
obtaining a pre-stored first correspondence relation between the peripheral component interconnect express cable number and a slot number, wherein the pre-stored first correspondence relation is a relation corresponding to the model of the computer device; and
determining, according to the pre-stored first correspondence relation, the slot number corresponding to the peripheral component interconnect express cable number of the field replaceable unit device.

In some embodiments, obtaining the model of the computer device and the peripheral component interconnect express cable number of the field replaceable unit device in response to that the field replaceable unit device of the peripheral component interconnect express bus of the computer device gives the fault alarm includes:
determining whether a field replaceable unit device is the field replaceable unit device of the peripheral component interconnect express bus in response to that the fault alarm of the field replaceable unit device in the computer device is received;
obtaining the model of the computer device and the peripheral component interconnect express cable number of the field replaceable unit device in response to that the field replaceable unit device is the field replaceable unit device of the peripheral component interconnect express bus;
determining, in response to that the field replaceable unit device is not the field replaceable unit device of the peripheral component interconnect express bus, a bus protocol type of the field replaceable unit device that gives the fault alarm; and
locating, by invoking a slot location program corresponding to the bus protocol type, a slot of the field replaceable unit device that gives the fault alarm.

In some embodiments, the obtaining the model of the computer device and the peripheral component interconnect express cable number of the field replaceable unit device includes:
determining a generation mode of a peripheral component interconnect express bus number bus device function (BDF) number of the field replaceable unit device that gives the fault alarm;
obtaining the model of the computer device and the peripheral component interconnect express cable number of the field replaceable unit device in response to that the generation mode of the BDF number is a dynamic allocation mode; and
obtaining the model of the computer device and the BDF number of the field replaceable unit device in response to that the generation mode of the BDF number is a fixed topology pre-allocated according to the slot; and
the method for determining a slot of a field replaceable unit device further includes:
obtaining a pre-stored second correspondence relation, corresponding to the model of the computer device, between the BDF number and the slot number; and
determining a slot number corresponding to the BDF number of the field replaceable unit device according to the second correspondence relation.

In some embodiments, after the determining the generation mode of the peripheral component interconnect express bus number BDF number of the field replaceable unit device that gives the fault alarm, the method for determining the slot of the field replaceable unit device further includes:
obtaining the peripheral component interconnect express cable number of the field replaceable unit device in response to that the generation mode of the BDF number is the fixed topology pre-allocated according to the slot;
obtaining the pre-stored first correspondence relation, corresponding to the model of the computer device, between the peripheral component interconnect express cable number and the slot number; and
determining, according to the pre-stored first correspondence relation, the slot number corresponding to the peripheral component interconnect express cable number of the field replaceable unit device.

In some embodiments, after the determining, according to the second correspondence relation, the slot number corresponding to the BDF number of the field replaceable unit device, the method for determining the slot of the field replaceable unit device further includes:
determining whether the slot number that is obtained according to the pre-stored first correspondence relation is consistent with the slot number that is obtained according to the second correspondence relation; and
controlling an alarm device to give an alarm in response to that the slot number that is obtained according to the pre-stored first correspondence relation is inconsistent with the slot number that is obtained according to the second correspondence relation.

In some embodiments, after the determining, according to the pre-stored first correspondence relation, the slot number corresponding to the peripheral component interconnect express cable number of the field replaceable unit device, the method for determining the slot of the field replaceable unit device further includes:
controlling a prompt device to give a prompt on the slot number that is obtained according to the pre-stored first correspondence relation and the slot number that is obtained according to the second correspondence relation.

In some embodiments, the prompt device includes a local prompt component and a remote prompt component.

In some embodiments, the method for determining the slot of the field replaceable unit device further includes:
receiving a configuration file of a first correspondence relation and/or a second correspondence relation corresponding to a specified type of computer device through a human-computer interaction apparatus; and
storing the configuration file in a nonvolatile storage unit.

In some embodiments, the method for determining the slot of the field replaceable unit device further includes:
modifying, according to a modification instruction received through the human-computer interaction apparatus, a correspondence relation in the configuration file specified.

In some embodiments, before the locating, by invoking a slot location program corresponding to the bus protocol type, a slot of the field replaceable unit device that gives the fault alarm, the method further includes:
integrating, with a slot location program of the peripheral component interconnect express bus, a slot location program corresponding to other bus protocol type other than the peripheral component interconnect express bus.

In some embodiments, a plurality of types of slot location programs corresponding to other bus protocol type are used.

In some embodiments, the obtaining a model of a computer device and a peripheral component interconnect express cable number of a field replaceable unit device includes one of the following:
obtaining the model of the computer device and the peripheral component interconnect express cable number of the field replaceable unit device by reading pre-stored data; and
making a request for the model of the computer device and the peripheral component interconnect express cable number of the field replaceable unit device by communicating with a target device.

In some embodiments, before the obtaining a pre-stored first correspondence relation between the peripheral component interconnect express cable number and a slot number, wherein the pre-stored first correspondence relation is a relation corresponding to the model of the computer device, the method further includes:
storing first correspondence relations of various models of computer devices in same location.

In some embodiments, the peripheral component interconnect express cable number includes a peripheral component interconnect express cable depth and a peripheral component interconnect express cable sub-number; and
determining, according to the pre-stored first correspondence relation, the slot number corresponding to the peripheral component interconnect express cable number of the field replaceable unit device includes:
determining, according to the pre-stored first correspondence relation, a slot number corresponding to the peripheral component interconnect express cable sub-number under the peripheral component interconnect express cable depth.

In some embodiments, before determining, according to the pre-stored first correspondence relation, a slot number corresponding to the peripheral component interconnect express cable sub-number under the peripheral component interconnect express cable depth, the method further includes:
establishing the pre-stored first correspondence relation among peripheral component interconnect express cable depths, peripheral component interconnect express cable sub-numbers and slot numbers of cable layers in response to that a plurality of peripheral component interconnect express cable layers are provided.

In some embodiments, after the determining the generation mode of the peripheral component interconnect express bus number BDF number of the field replaceable unit device that gives the fault alarm, the method for determining the slot of the field replaceable unit device further includes:
obtaining the model of the computer device, the peripheral component interconnect express cable number of the field replaceable unit device and the BDF number of the field replaceable unit device in response to that a peripheral component interconnect express device topology of the computer device has a mixed structure of a preset slot and a self-defined cable, and a generation mode of a BDF number of the preset slot is inconsistent with a generation mode of a BDF number of a slot corresponding to the self-defined cable;
obtaining the pre-stored first correspondence relation and the second correspondence relation that are pre-stored and correspond to the model of the computer device; and
determining the slot number of the field replaceable unit device according to the pre-stored first correspondence relation, the second correspondence relation, the peripheral component interconnect express cable number of the field replaceable unit device and the BDF number of the field replaceable unit device.

In some embodiments, determining the slot number of the field replaceable unit device according to the pre-stored first correspondence relation, the second correspondence relation, the peripheral component interconnect express cable number of the field replaceable unit device and the BDF number of the field replaceable unit device includes:
determining a correspondence relation and a number that correspond to the generation mode of the BDF number of the preset slot from the pre-stored first correspondence relation, the second correspondence relation, the peripheral component interconnect express cable number of the field replaceable unit device and the BDF number of the field replaceable unit device;
determining whether a slot corresponding to the number determined is found according to the correspondence relation determined; and
searching for a slot number corresponding to another undetermined number from another undetermined correspondence relation in response to that the slot is not found.

In order to solve the technical problem, the embodiments of the disclosure further provides an apparatus for determining a slot of a field replaceable unit device. The apparatus includes:
a first obtainment component configured to obtain a model of a computer device and a peripheral component interconnect express cable number of a field replaceable unit device in response to that the field replaceable unit device of a peripheral component interconnect express bus of the computer device gives a fault alarm;
a second obtainment component configured to obtain a pre-stored first correspondence relation between the peripheral component interconnect express cable number and a slot number, wherein the pre-stored first correspondence relation is a relation corresponding to the model of the computer device; and
a determination component configured to determine, according to the pre-stored first correspondence relation, the slot number corresponding to the peripheral component interconnect express cable number of the field replaceable unit device.

In order to solve the technical problem, the embodiments of the disclosure further provide a device for determining a slot of a field replaceable unit device. The device includes:
a memory configured to store a computer program; and
a processor configured to implement steps of the method for determining a slot of a field replaceable unit device described above when executing the computer program.

In order to solve the technical problems, the embodiments of the disclosure further provide a computer-readable nonvolatile storage medium. The computer-readable nonvolatile storage medium stores a computer program, where the computer program implements steps of the method for determining a slot of a field replaceable unit device described above when executed by a processor.

The embodiments of the disclosure further provide the apparatus and device for determining a slot of a field replaceable unit device, and the computer-readable nonvolatile storage medium, which have the same beneficial effects as the method for determining a slot of a field replaceable unit device described above.

### BRIEF DESCRIPTION OF THE DRAWINGS

To describe technical solutions in embodiments of the disclosure more clearly, accompanying drawings required in the related art or the embodiments will be briefly described below. Apparently, the accompanying drawings in the following description merely show some embodiments of the disclosure, and a person of ordinary skill in the art may still derive other accompanying drawings from these accompanying drawings without creative efforts.

FIG. 1 is a schematic flowchart of a method for determining a slot of a field replaceable unit (FRU) device according to the embodiments of the disclosure;

FIG. 2 is a diagram of a peripheral component interconnect express (PCIe) device topology that has a mixed structure of a preset slot and a self-defined cable according to the embodiments of the disclosure;

FIG. 3 is a schematic structural diagram of an apparatus for determining a slot of an FRU device according to the embodiments of the disclosure; and

FIG. 4 is a schematic structural diagram of a device for determining a slot of an FRU device according to the embodiments of the disclosure.

### DETAILED DESCRIPTION OF THE EMBODIMENTS

Embodiments of the disclosure are to provide a method for determining a slot of a field replaceable unit device. A set of programs is preset in the disclosure, and includes a first correspondence relation between peripheral component interconnect express (PCIe) numbers and slot numbers of different models of computer devices. In this way, a slot may be quickly and accurately determined through this set of programs when field replaceable units (FRUs) of various types of computer devices give a fault alarm, and user experience is improved accordingly. Another objective of the embodiments of the disclosure is to provide an apparatus and device for determining a slot of a field replaceable unit device, and a computer-readable nonvolatile storage medium. A set of programs is preset in the disclosure, and includes a first correspondence relation between PCIe cable numbers and slot numbers of different models of computer devices. In this way, a slot may be quickly and accurately determined through this set of programs when FRUs of various types of computer devices give a fault alarm, and user experience is improved accordingly.

To make the objectives, technical solutions, and advantages of the embodiments of the disclosure clearer, the technical solutions in the embodiments of the disclosure will be clearly and completely described below with reference to accompanying drawings in the embodiments of the disclosure. Apparently, the embodiments described are some embodiments rather than all embodiments of the disclosure. All other embodiments derived by a person of ordinary skill in the art from the embodiments of the disclosure without creative efforts should fall within the protection scope of the disclosure.

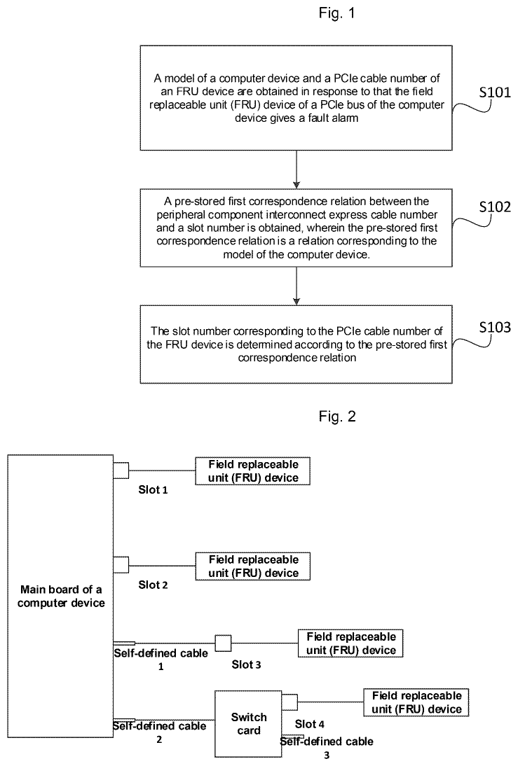

As shown in FIG. 1, FIG. 1 is a schematic flowchart of a method for determining a slot of an FRU device according to the embodiments of the disclosure. The method for determining a slot of an FRU device may be executed by a computer device which has at least one of a field replaceable unit device. The method for determining a slot of an FRU device includes:

S101: A model of a computer device and a PCIe cable number of an FRU device are obtained in response to that the field replaceable unit (FRU) device of a PCIe bus of the computer device gives a fault alarm.

Alternatively, in consideration of the technical problem in the background, a specific model of computer device has a certain model of case and a certain model of main board, and has a definite peripheral component interconnect express (PCIe) topology. In this case, a PCIe cable number corresponding to each slot is definite. Thus after each slot is numbered, a correspondence relation between the PCIe cable number and a slot number may be established accordingly, so as to automatically determine a slot number of a faulty FRU device according to this correspondence relation. In consideration of the fact that PCIe topologies of different models of computer devices vary, a high development cost and a high maintenance cost are caused if a set of programs that includes the correspondence relation is specially developed for each model of computer device to determine the slot. In view of this, in order to unify software, the embodiments of the disclosure set a first correspondence relation between PCIe cable numbers and slot numbers of various models of computer devices in one set of programs, software corresponding to this program may be applied to the various models of computer devices as universal software, and the slot number corresponding to the faulty FRU may be determined through the pre-stored first correspondence relation correspondingly.

It is worth mentioning that for S101, the condition that “the PCIe cable number corresponding to each slot is definite” is merely limited to a PCIe device, but FRU devices of other protocol buses are further arranged in the computer device. Thus the embodiments of the disclosure may be merely triggered in response to that a field replaceable unit (FRU) device of the PCIe bus of the computer device gives a fault alarm.

The model of the computer device and the PCIe cable number of the FRU device may be obtained by various methods, for example, by reading pre-stored data, or making, by communicating with a target device, a request for the model and PCIe cable number, which is not limited herein by the embodiments of the disclosure.

Alternatively, a plurality of types of computer devices may be used and include computer devices used in, for example, fields of storage, servers, cloud data centers, information technology (IT) and embedded counting, which is not limited herein by the embodiments of the disclosure.

S102: A pre-stored first correspondence relation between the peripheral component interconnect express cable number and a slot number is obtained, wherein the pre-stored first correspondence relation is a relation corresponding to the model of the computer device.

Alternatively, after the model of the computer device is obtained, the pre-stored first correspondence relation between the PCIe cable number and the slot number may be determined at first, so as to act as a data basis for following steps, wherein the pre-stored first correspondence relation is a relation corresponding to the model of the computer device.

The pre-stored first correspondence relations of various models of computer devices may be stored in the same place together. For example, the pre-stored first correspondence relations may be stored locally in the computer device, or may be stored in a cloud server and downloaded when used, which is not limited herein by the embodiments of the disclosure.

S103: The slot number corresponding to the PCIe cable number of the FRU device is determined according to the pre-stored first correspondence relation.

Alternatively, after the pre-stored first correspondence relation is obtained, the slot number corresponding to the PCIe cable number of the FRU device may be found by the pre-stored first correspondence relation, and the slot number of the faulty FRU may be quickly and accurately determined. Thus a worker may quickly find the FRU and implement replacement work, and work efficiency and user experience are improved.

According to the method for determining a slot of an FRU device of the disclosure, in consideration of the facts that the PCIe topologies of different models of computer devices vary, and in a computer device that has a definite PCIe topology, slots of FRU devices have fixed correspondence relations with PCIe cable numbers, a set of programs is preset in the disclosure, and includes first correspondence relations between PCIe cable numbers and slot numbers of different models of computer devices. In this way, a slot may be quickly and accurately determined through this set of programs when an FRU of each type of computer device gives a fault alarm, and the user experience is improved accordingly.

On the basis of the embodiments described above:
In some embodiments, the step that a model of a computer device and a PCIe cable number of an FRU device are obtained in response to that the FRU device of a PCIe bus of the computer device gives a fault alarm includes:
whether an FRU device is the FRU device of the PCIe bus is determined in response to that the fault alarm of the FRU device in the computer device is received;
the model of the computer device and the PCIe cable number of the field replaceable unit device are obtained in response to that the FRU device is the FRU device of the PCIe bus;
a bus protocol type of the FRU device that gives the fault alarm is determined in response to that the FRU device is not the FRU device of the PCIe bus; and
a slot of the FRU device that gives the fault alarm is located by invoking a slot location program corresponding to the bus protocol type.

Alternatively, in consideration of the fact that a method for locating the slot of the FRU device of the PCIe bus is different from a method for locating a slot of an FRU device of other protocol buses, whether the FRU device is the FRU device of the PCIe bus is determined in response to that the fault alarm of the FRU device in the computer device is received. The bus protocol type of the FRU device that gives the fault alarm may be determined in response to that the FRU device is not the FRU device of the PCIe bus, and a slot location program corresponding to other bus protocol type may be integrated with the slot location program of the PCIe bus in the embodiments of the disclosure for the convenience of software development and maintenance.

A plurality of types of slot location programs corresponding to the other bus protocol type are used, which is not limited herein by the embodiments of the disclosure.

In some embodiments, the step that the model of the computer device and the PCIe cable number of the field replaceable unit device are obtained includes:
a generation mode of a PCIe bus number bus device function (BDF) number of the FRU device that gives the fault alarm is determined;
the model of the computer device and the PCIe cable number of the FRU device are obtained in response to that the generation mode of the BDF number is a dynamic allocation mode; and
the model of the computer device and the BDF number of the FRU device are obtained in response to that the generation mode of the BDF number is a fixed topology pre-allocated according to the slot; and
the method for determining a slot of an FRU device further includes:
a pre-stored second correspondence relation, corresponding to the model of the computer device, between the BDF number and the slot number is obtained; and
a slot number corresponding to the BDF number of the FRU device is determined according to the second correspondence relation.

Alternatively, the generation mode of the bus device function (BDF) number in the computer device usually includes the dynamic allocation mode/fixed topology pre-allocated according to the slot. The slot has a definite correspondence relation with the BDF number in the case of the fixed topology pre-allocated according to the slot, the correspondence relation between the slot number and the BDF number may be determined after the slots are numbered, and the slot number corresponding to the BDF number of the FRU device may be determined through the second correspondence relation. Since the BDF number is unlike a number of the multi-layered PCIe cables (arranged in such a way that each layer has a PCIe cable number), that is, merely one layer of BDF number is arranged, and the BDF number is simpler and faster to obtain, the model of the computer device, the PCIe cable number of the FRU device, and the second correspondence relation, corresponding to the model of the computer device, between the BDF number and the slot number may be obtained in response to that the generation mode of the BDF number is the fixed topology pre-allocated according to the slot in the embodiments of the disclosure. Then the slot number corresponding to the BDF number of the FRU device may be determined according to the second correspondence relation, thus improving working efficiency.

In addition, the generation mode of the dynamic allocation mode of the BDF number results in a lack of a definite correspondence between the BDF numbers and the slot. In the case of this generation mode, the slot number corresponding to the PCIe cable number may be determined according to the pre-stored first correspondence relation in the embodiments of the disclosure.

In some embodiments, after the step that a generation mode of a PCIe bus number BDF number of the FRU device that gives the fault alarm is determined, the method for determining a slot of an FRU device further includes:
the PCIe cable number of the FRU device is obtained in response to that the generation mode of the BDF number is the fixed topology pre-allocated according to the slot;
the pre-stored first correspondence relation, corresponding to the model of the computer device, between the PCIe cable number and the slot number is obtained; and
the slot number corresponding to the PCIe cable number of the FRU device is determined according to the pre-stored first correspondence relation.

Alternatively, although a corresponding slot number may be determined according to the BDF number in response to that the generation mode of the BDF number is the fixed topology pre-allocated according to the slot, a single determination mode is prone to inevitable error. In view of that, in order to improve accuracy of the slot number determined, the slot number corresponding to the PCIe cable number of the faulty FRU device may be further determined according to the pre-stored first correspondence relation besides the generation mode of the BDF number in this embodiments of the disclosure. Thus a user may verify accuracy of the slot number by comparing slots numbers determined by two modes.

In some embodiments, after the step that a slot number corresponding to the BDF number of the FRU device is determined according to the second correspondence relation, the method for determining a slot of an FRU device further includes:
whether the slot number that is obtained according to the pre-stored first correspondence relation is consistent with the slot number that is obtained according to the second correspondence relation is determined; and
an alarm device is controlled to give an alarm in response to an inconsistency.

Alternatively, in order to prevent the condition that the user forgets to compare the slot numbers determined in two modes, and inconsistency between the two slot numbers cannot be found undoubtedly in this case, whether the slot number that is obtained according to the pre-stored first correspondence relation is consistent with the slot number that is obtained according to the second correspondence relation may be automatically determined in the embodiments of the disclosure, and the alarm device is controlled to give the alarm in response to of the inconsistency. Thus the user may find this condition in time and take a corresponding measure, for example, debugging software or the pre-stored correspondence relation, and prevent related problems caused by an error of the slot number accordingly.

A plurality of alarm devices may be used, for example, a voice broadcast device, which is not limited herein by the embodiments of the disclosure.

In some embodiments, after the step that the slot number corresponding to the PCIe cable number of the FRU device is determined according to the pre-stored first correspondence relation, the method for determining a slot of an FRU device further includes:
a prompt device is controlled to give a prompt on the slot number that is obtained according to the pre-stored first correspondence relation and the slot number that is obtained according to the second correspondence relation.

Alternatively, in order to make the worker to know the slot number conveniently and quickly, the prompt device may be controlled to give the prompt on the slot number that is obtained according to the pre-stored first correspondence relation and the slot number that is obtained according to the second correspondence relation in the embodiments of the disclosure. The prompt on the two slot numbers is given for the worker to compare.

In some embodiments, the prompt device includes a local prompt component and a remote prompt component.

Alternatively, since the worker may be located locally or remotely, the prompt device in the embodiments of the disclosure includes the local prompt component and the remote prompt component in order to make the worker know prompt information timely in different scenarios.

Alternatively, a plurality of prompt components may be used. For example, the local prompt component may be a display, and the remote prompt component may be a mobile phone, etc., which is not limited herein by the embodiments of the disclosure.

In some embodiments, the method for determining a slot of an FRU device further includes: a configuration file of a first correspondence relation and/or a second correspondence relation corresponding to a specified type of computer device is received through a human-computer interaction apparatus; and
the configuration file is stored in a nonvolatile storage unit.

Alternatively, in consideration of the fact that an application scope of this set of programs needs to be correspondingly expanded as the type of computer device on the market increases, the worker may send the configuration file through the human-computer interaction apparatus, so as to increase the pre-stored first correspondence relation and/or the second correspondence relation corresponding to a specified type of computer device. By arranging the form of the configuration file, work efficiency is improved by merely adding the configuration file corresponding to the type of computer device without changing original contents of the whole set of programs.

In some embodiments, the method for determining a slot of an FRU device further includes: A correspondence relation in the configuration file specified is modified according to a modification instruction received through the human-computer interaction apparatus.

Alternatively, in consideration of the fact that the correspondence relation in an existing configuration file in the system may have an error, the worker may actively modify, through the modification instruction, the correspondence relation in the configuration file specified after the error is discovered. Thus determination accuracy of the slot is improved.

In some embodiments, the PCIe cable number includes a PCIe cable depth and a PCIe cable sub-number.

The step that the slot number corresponding to the PCIe cable number of the FRU device is determined according to the pre-stored first correspondence relation includes:
a slot number corresponding to the PCIe cable sub-number under the PCIe cable depth is determined according to the pre-stored first correspondence relation.

Alternatively, a plurality of PCIe cable layers are arranged in some PCIe topologies, depths of a plurality of layers are involved, and the PCIe cable is numbered separately for each layer of depth. In view of that, the PCIe cable number in the embodiments of the disclosure includes the PCIe cable depth and the PCIe cable sub-number, and the slot number of the FRU may be accurately and efficiently determined in a multi-layer PCIe cable scenario.

In order to better describe the embodiments of the disclosure, reference may be made to tables 1 and 2 below. Table 1 is a schematic table of the pre-stored first correspondence relation and Table 2 is a schematic table of the second correspondence relation.

TABLE 1

| Model of a | | | | | Note (with a real |
|---|---|---|---|---|---|
| case/main | | | | Slot | scenario as an |
| board | LanID_Depth1 | LanID_Depth2 | LanID_Depth . . . N | number | example) |
| A | Lan[0-7] | NA | NA | HBA2 | CPULan[0-7] is |
| | | | | | directly connected |
| | | | | | to No. 2 slot |
| | | | | | interface card |
| | Lan[8-15] | Lan[12-15] | NA | HBA3 | CPULan[8-15] is |
| | | | | | connected to No. |
| | | | | | 3 slot interface |
| | | | | | card through |
| | | | | | switchLan[12-15] |
| | Lan[8-15] | Lan[16-23] | Lan[8-9] | SSD1 | CPULan[8-15] is |
| | | | | | connected to |
| | | | | | switch2 through |
| | | | | | switchlLan[12-15], |
| | | | | | switch2Lan[8-9] |
| | | | | | is connected to |
| | | | | | NVMeSSD of No. |
| | | | | | 1 slot |

TABLE 2

| Model of a case/ | | | Note (with a real scenario as |
|---|---|---|---|
| main board | BDF | Slot | an example) |
| A | BUS[1-9] | HBA1 | BUS[1-9] is allocated to host |
| | | | bus adapter (HBA) card slot 1 |
| | BUS[10] | SSD_3 | BUS[10] is allocated to |
| | | | NVMeSSD slot 3 |
| | BUS[11] | SSD_5 | BUS[10] is allocated to |
| | | | NVMeSSD slot 5 |
| | BUS[12] | SSD_6 | BUS[10] is allocated to |
| | | | NVMeSSD slot 6 |
| | BUS[61-63] | HBA1 | BUS[61-63] is allocated to |
| | | | HBA card slot 3 |
| B | BUS[1-6] | 1 | . . . |
| | BUS[9-12] | 2 | . . . |
| | BUS[76-88] | 3 | . . . |

Alternatively, in Table 1, the model of the case/main board also denotes the model of computer device, and LanID_DepthN denotes a PCIe cable depth of an N^{th} layer.

The embodiments of the disclosure will be better described with reference to FIG. 2. FIG. 2 is a diagram of a PCIe device topology that has a mixed structure of a preset slot and a self-defined cable according to the embodiments of the disclosure. In some embodiments, after the step that a generation mode of a PCIe bus number BDF number of the FRU device that gives the fault alarm is determined, the method for determining a slot of an FRU device further includes:
the model of the computer device, the PCIe cable number of the FRU device and the BDF number of the FRU device are obtained in response to that a PCIe device topology of the computer device has a mixed structure of a preset slot and a self-defined cable, and a generation mode of a BDF number of the preset slot is inconsistent with a generation mode of a BDF number of a slot corresponding to the self-defined cable;
the pre-stored first correspondence relation and the second correspondence relation that are pre-stored and correspond to the model of the computer device are obtained; and
the slot number of the FRU device is determined according to the pre-stored first correspondence relation, the second correspondence relation, the PCIe cable number of the FRU device and the BDF number of the FRU device.

Alternatively, the PCIe device topology of some computer devices is the mixed structure of the preset slot and the self-defined cable, and the user may define the self-defined cable as a PCIe sub-topology of a specified form. For example, with reference to FIG. 2, in addition to preset slots 1 and 2 that are originally provided in the main board of the computer device, self-defined cables 1 and 2 are further arranged, a slot 3 and a SWITCH card may be defined on the self-defined cable. A slot 4 and a self-defined cable 3 may further extend from the downstream of the SWITCH card, and the self-defined cable 3 may further be self-defined as a new slot or configured to connect a new Switch card. Moreover, in this case, the generation modes of the BDF of the preset slot and “PCIe sub-topology defined by the self-defined cable” are likely to be different, and the slot number of the faulty FRU device cannot be determined by using a single correspondence relation thus. In view of that, in the embodiments of the disclosure, the model of the computer device, the PCIe cable number of the FRU device and the BDF number of the FRU device may be obtained, then the pre-stored first correspondence relation and the second correspondence relation that are pre-stored and correspond to the computer device model may be obtained, and finally, the slot number of the FRU device may be determined according to the pre-stored first correspondence relation, the second correspondence relation, the PCIe cable number of the FRU device and the BDF number of the FRU device. Thus the slot number of the faulty FRU device may be determined quickly and accurately in this mixed structure.

In some embodiments, the step that the slot number of the FRU device is determined according to the pre-stored first correspondence relation, the second correspondence relation, the PCIe cable number of the FRU device and the BDF number of the FRU device includes:
a correspondence relation and a number that correspond to the generation mode of the BDF number of the preset slot is determined from the pre-stored first correspondence relation, the second correspondence relation, the PCIe cable number of the FRU device and the BDF of the FRU device;
whether a slot corresponding to the number determined is found according to the correspondence relation determined is determined; and
a slot number corresponding to another undetermined number is searched for from another undetermined correspondence relation in response to that the slot is not found.

Alternatively, the generation modes of the BDF numbers of the preset slots and the PCIe sub-topology corresponding to the self-defined cables are different. In the embodiments of the disclosure, the slot number may be searched for according to one correspondence relation, and be further searched for by using another correspondence relation if the first searching fails. In the embodiments of the disclosure, the correspondence relation and the number that correspond to the generation mode of the BDF number of the preset slot may be determined at first from the pre-stored first correspondence relation, the second correspondence relation, the PCIe cable number of the FRU device and the BDF of the FRU device, searching is performed by using the correspondence relation and the number that are determined, and if the searching fails, searching is re-performed by using another correspondence relation and another number that are not determined. Clear logic and a high searching speed are achieved.

It is clear that besides this specific embodiment, the step that the slot number of the FRU device may be further determined according to the pre-stored first correspondence relation, the second correspondence relation, the PCIe cable number of the FRU device and the BDF number of the FRU device may adopt another specific embodiment, which is not limited herein by the embodiments of the disclosure.

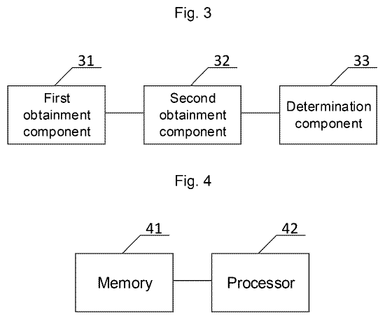

As shown in FIG. 3, FIG. 3 is a schematic structural diagram of an apparatus for determining a slot of an FRU device according to the embodiments of the disclosure. The apparatus for determining a slot of an FRU device may be installed in a computer device which has at least one of a field replaceable unit device. The apparatus for determining a slot of an FRU device includes: a first obtainment component 31 configured to obtain a model of a computer device and a PCIe cable number of a FRU device in response to that the FRU device of a PCIe bus of the computer device gives a fault alarm;
a second obtainment component 32 configured to obtain a pre-stored first correspondence relation between the peripheral component interconnect express cable number and a slot number, wherein the pre-stored first correspondence relation is a relation corresponding to the model of the computer device; and
a determination component 33 configured to determine, according to the pre-stored first correspondence relation, the slot number corresponding to the PCIe cable number of the FRU device.

According to the apparatus for determining a slot of an FRU device of the disclosure, in consideration of the facts that PCIe topologies of different models of computer devices vary, and in a computer device that has a definite PCIe topology, slots of FRU devices have fixed correspondence relations with PCIe cable numbers, a set of programs is preset in the disclosure, and includes first correspondence relations between PCIe cable numbers and slot numbers of different models of computer devices. In this way, a slot may be quickly and accurately determined through this set of programs when an FRU of each type of computer device gives a fault alarm, and user experience is improved accordingly.

In some embodiments, the first obtainment component includes:
a first decision component configured to determine whether an FRU device is the FRU device of the PCIe bus in response to that the fault alarm of the FRU device in the computer device is received, trigger a first obtainment sub-component in response to that the FRU device is the FRU device of the PCIe bus, and trigger a first determination sub-component in response to that the FRU device is not the FRU device of the PCIe bus;
the first obtainment sub-component configured to obtain the model of the computer device and the PCIe cable number of the FRU device;
the first determination sub-component configured to determine a bus protocol type of the FRU device that gives the fault alarm; and
a second determination sub-component configured to locate, by invoking a slot location program corresponding to the bus protocol type, a slot of the FRU device that gives the fault alarm. In some embodiments, the first obtainment sub-component includes:
a third determination sub-component configured to determine a generation mode of a PCIe bus number BDF number of the FRU device that gives the fault alarm;
a first obtainment sub-component configured to obtain the model of the computer device and the PCIe cable number of the FRU device in response to that the generation mode of the BDF number is a dynamic allocation mode; and
a second obtainment sub-component configured to obtain the model of the computer device and the BDF number of the FRU device in response to that the generation mode of the BDF number is a fixed topology pre-allocated according to the slot.

The apparatus for determining a slot of an FRU device further includes:
a third obtainment sub-component configured to obtain a pre-stored second correspondence relation, corresponding to the model of the computer device, between the BDF number and the slot number; and
a fourth determination sub-component configured to determine, according to the second correspondence relation, the slot number corresponding to the BDF number of the FRU device.

In some embodiments, the apparatus for determining a slot of an FRU device further includes:
a fourth obtainment sub-component configured to obtain the PCIe cable number of the FRU device in response to that the generation mode of the BDF number is the fixed topology pre-allocated according to the slot;
a fifth obtainment sub-component configured to obtain the pre-stored first correspondence relation, corresponding to the model of the computer device, between the PCIe cable number and a slot number; and
a fifth determination sub-component configured to determine, according to the pre-stored first correspondence relation, the slot number corresponding to the PCIe cable number of the FRU device.

In some embodiments, the apparatus for determining a slot of an FRU device further includes:
a second decision sub-component configured to determine whether the slot number that is obtained according to the pre-stored first correspondence relation is consistent with the slot number that is obtained according to the second correspondence relation; and trigger an alarm control component in response to of inconsistency; and
the alarm control component configured to control an alarm device to give an alarm.

In some embodiments, the apparatus for determining a slot of an FRU device further includes:
a sixth obtainment sub-component configured to obtain the model of the computer device, the PCIe cable number of the FRU device and the BDF number of the FRU device in response to that a PCIe device topology of the computer device has a mixed structure of a preset slot and a self-defined cable, and a generation mode of a BDF number of the preset slot is inconsistent with a generation mode of a BDF number of a slot corresponding to the self-defined cable;
a seventh obtainment sub-component configured to obtain the pre-stored first correspondence relation and the second correspondence relation that are pre-stored and correspond to the model of the computer device; and
a sixth determination sub-component configured to determine the slot number of the FRU device according to the pre-stored first correspondence relation, the second correspondence relation, the PCIe cable number of the FRU device and the BDF number of the FRU device.

In some embodiments, the sixth determination sub-component includes:
a seventh determination sub-component configured to determine a correspondence relation and a number that correspond to the generation mode of the BDF number of the preset slot from the pre-stored first correspondence relation, the second correspondence relation, the PCIe cable number of the FRU device and the BDF number of the FRU device;
a third decision sub-component configured to determine whether a slot corresponding to the number determined is found according to the correspondence relation determined; and trigger a search component in response to that no slot is found; and
the search component configured to search for a slot number corresponding to another undetermined number from another undetermined correspondence relation.

Reference may be made to the foregoing embodiment of the method for determining a slot of an FRU device for description of the apparatus for determining a slot of an FRU device according to the embodiments of the disclosure, which is not repeated herein by the embodiments of the disclosure.

As shown in FIG. 4, FIG. 4 is a schematic structural diagram of a device for determining a slot of an FRU device according to the embodiments of the disclosure. The device for determining a slot of an FRU device includes:
a memory 41 configured to store a computer program; and
a processor 42 configured to implement steps of the method for determining a slot of an FRU device of the foregoing embodiments in response to that execute the computer program.

Alternatively, the memory includes a nonvolatile storage medium and an internal memory. The nonvolatile storage medium stores an operation system and a computer-readable instruction. The internal memory provides an environment for operation of the operation system and the computer-readable instruction in the nonvolatile storage medium. When executing the computer program stored in the memory, the processor may implement: a model of a computer device and a PCIe cable number of an FRU device are obtained in response to that the FRU device of a PCIe bus of the computer device gives a fault alarm; a pre-stored first correspondence relation, corresponding to the model of the computer device, between the PCIe cable number and a slot number is obtained; and the slot number corresponding to the PCIe cable number of the FRU device is determined according to the pre-stored first correspondence relation.

According to the device for determining a slot of an FRU device of the disclosure, in consideration of the facts that the PCIe topologies of different models of computer devices vary, and in a computer device that has a definite PCIe topology, slots of FRU devices have fixed correspondence relations with PCIe cable numbers, a set of programs is preset in the disclosure, and includes first correspondence relations between PCIe cable numbers and slot numbers of different models of computer devices. In this way, a slot may be quickly and accurately determined through this set of programs when an FRU of each type of computer device gives a fault alarm, and the user experience is improved accordingly.

In some embodiments, When executing a computer sub-program stored in the memory, the processor may implement: whether an FRU device is the FRU device of the PCIe bus is determined in response to that the fault alarm of the FRU device in the computer device is received;
the model of the computer device and the PCIe cable number of the field replaceable unit device are obtained in response to that the FRU device is the FRU device of the PCIe bus;
a bus protocol type of the FRU device that gives the fault alarm is determined in response to that the FRU device is not the FRU device of the PCIe bus; and
a slot of the field replaceable unit device that gives the fault alarm is located by invoking a slot location program corresponding to the bus protocol type.

In some embodiments, when executing the computer sub-program stored in the memory, the processor may implement:
a generation mode of a PCIe bus number BDF number of the FRU device that gives the fault alarm is determined;
the model of the computer device and the PCIe cable number of the FRU device are obtained in response to that the generation mode of the BDF number is a dynamic allocation mode;
the model of the computer device and the BDF number of the FRU device are obtained in response to that the generation mode of the BDF number is a fixed topology pre-allocated according to the slot;
a pre-stored second correspondence relation, corresponding to the model of the computer device, between the BDF number and the slot number is obtained; and
a slot number corresponding to the BDF number of the FRU device is determined according to the second correspondence relation.

In some embodiments, when executing the computer sub-program stored in the memory, the processor may implement: the PCIe cable number of the FRU device is obtained in response to that the generation mode of the BDF number is the fixed topology pre-allocated according to the slot;
the pre-stored first correspondence relation, corresponding to the model of the computer device, between the PCIe cable number and a slot number is obtained; and
the slot number corresponding to the PCIe cable number of the FRU device is determined according to the pre-stored first correspondence relation.

In some embodiments, when executing the computer sub-program stored in the memory, the processor may implement:
whether the slot number that is obtained according to the pre-stored first correspondence relation is consistent with the slot number that is obtained according to the second correspondence relation is determined; and
an alarm device is controlled to give an alarm in response to of inconsistency.

In some embodiments, when executing the computer sub-program stored in the memory, the processor may implement:
the model of the computer device, the PCIe cable number of the FRU device and the BDF number of the FRU device are obtained in response to that a PCIe device topology of the computer device has a mixed structure of a preset slot and a self-defined cable, and a generation mode of a BDF number of the preset slot is inconsistent with a generation mode of a BDF number of a slot corresponding to the self-defined cable;
the pre-stored first correspondence relation and the second correspondence relation that are pre-stored and correspond to the model of the computer device are obtained; and
the slot number of the FRU device is determined according to the pre-stored first correspondence relation, the second correspondence relation, the PCIe cable number of the FRU device and the BDF number of the FRU device.

In some embodiments, when executing the computer sub-program stored in the memory, the processor may implement:
a correspondence relation and a number that correspond to the generation mode of the BDF number of the preset slot is determined from the pre-stored first correspondence relation, the second correspondence relation, the PCIe cable number of the FRU device and the BDF of the FRU device;
whether a slot corresponding to the number determined is found according to the correspondence relation determined is determined; and
a slot number corresponding to another undetermined number is searched for from another undetermined correspondence relation in response to that the slot is not found.

Reference may be made to the foregoing example of the method for determining a slot of an FRU device for description of the device for determining a slot of an FRU device according to the embodiments of the disclosure, which is not repeated herein by the embodiments of the disclosure.

The embodiments of the disclosure further provide a computer-readable nonvolatile storage medium. The computer-readable nonvolatile storage medium stores a computer program, where the computer program implements steps of the method for determining a slot of an FRU device of the foregoing example when executed by a processor.

Reference may be made to the foregoing example of the method for determining a slot of an FRU device for description of the computer-readable nonvolatile storage medium according to the embodiments of the disclosure, which is not repeated herein by the embodiments of the disclosure.

The embodiments of the description are described in a progressive mode, each embodiment focuses on the difference from other embodiments, and the same and similar parts between the embodiments may refer to each other. The apparatus disclosed in the embodiment corresponds to the method disclosed in the embodiment, and is described relatively simply, and reference may be made to description of the method for relevant contents. It should be further noted that in the description, relational terms such as first and second are merely used to distinguish one entity or operation from another entity or operation, and do not necessarily require or imply any such actual relation or order among these entities or operations. In addition, the terms “include”, “include” or their any variation are intended to be non-exclusive, such that a process, method, article or device that includes a series of elements not only includes those elements, but includes other elements not listed clearly, or further includes elements inherent to such a process, method, article or device. In the case of no more limitation, an element limited by the phrase “include a . . . ” or “include a . . . ” does not exclude other same element existing in the process, method, article or device including the element.

Through the description of the embodiments disclosed, those skilled in the art may implement or use the disclosure. Many modifications to these embodiments will be apparent to those skilled in the art, and general principles defined herein may be implemented in other embodiments without departing from the spirit or scope of the disclosure. Thus the disclosure is not limited to these embodiments shown herein, but should cover the widest scope consistent with principles and novel features disclosed herein.

1. A method for determining a slot of a field replaceable unit device comprising:
Obtaining, by a computer device which has at least one of a field replaceable unit device, a model of a computer device and a peripheral component interconnect express cable number of a field replaceable unit device in response to that the field replaceable unit device of a peripheral component interconnect express bus of the computer device gives a fault alarm;
Obtaining, by the computer device, a pre-stored first correspondence relation between the peripheral component interconnect express cable number and a slot number, wherein the pre-stored first correspondence relation is a relation corresponding to the model of the computer device; and
determining, by the computer device, the slot number corresponding to the peripheral component interconnect express cable number of the field replaceable unit device, according to the pre-stored first correspondence relation.

2. The method for determining the slot of the field replaceable unit device as claimed in claim 1, wherein the obtaining the model of the computer device and the peripheral component interconnect express cable number of the field replaceable unit device in response to that the field replaceable unit device of the peripheral component interconnect express bus of the computer device gives a fault alarm alternatively comprises:
determining whether a field replaceable unit device is the field replaceable unit device of the peripheral component interconnect express bus in response to that the fault alarm of the field replaceable unit device in the computer device is received;
obtaining the model of the computer device and the peripheral component interconnect express cable number of the field replaceable unit device in response to that the field replaceable unit device is the field replaceable unit device of the peripheral component interconnect express bus;
determining, in response to that the field replaceable unit device is not the field replaceable unit device of the peripheral component interconnect express bus, a bus protocol type of the field replaceable unit device that gives the fault alarm; and
locating, by invoking a slot location program corresponding to the bus protocol type, a slot of the field replaceable unit device that gives the fault alarm.

3. The method for determining the slot of the field replaceable unit device as claimed in claim 2, wherein obtaining the model of the computer device and the peripheral component interconnect express cable number of the field replaceable unit device comprises:
determining a generation mode of a peripheral component interconnect express bus number bus device function number of the field replaceable unit device that gives the fault alarm;
obtaining the model of the computer device and the peripheral component interconnect express cable number of the field replaceable unit device in response to that the generation mode of the bus device function number is a dynamic allocation mode; and
obtaining the model of the computer device and the bus device function number of the field replaceable unit device in response to that the generation mode of the bus device function number is a fixed topology pre-allocated according to the slot; and
the method for determining a slot of a field replaceable unit device further comprises:
obtaining a pre-stored second correspondence relation, corresponding to the model of the computer device, between the bus device function number and the slot number; and
determining, according to the second correspondence relation, a slot number corresponding to the bus device function number of the field replaceable unit device.

4. The method for determining the slot of the field replaceable unit device as claimed in claim 3, wherein after the determining the generation mode of the peripheral component interconnect express bus number bus device function number of the field replaceable unit device that gives the fault alarm, the method for determining the slot of the field replaceable unit device further comprises;
obtaining the peripheral component interconnect express cable number of the field replaceable unit device in response to that the generation mode of the bus device function number is the fixed topology pre-allocated according to the slot;
obtaining the pre-stored first correspondence relation, corresponding to the model of the computer device, between the peripheral component interconnect express cable number and the slot number; and
determining, according to the pre-stored first correspondence relation, the slot number corresponding to the peripheral component interconnect express cable number of the field replaceable unit device.

5. The method for determining the slot of the field replaceable unit device as claimed in claim 4, wherein after the determining, according to the second correspondence relation, the slot number corresponding to the bus device function number of the field replaceable unit device, the method for determining the slot of the field replaceable unit device further comprises:
determining whether the slot number that is obtained according to the pre-stored first correspondence relation is consistent with the slot number that is obtained according to the second correspondence relation; and
controlling an alarm device to give an alarm in response to that the slot number that is obtained according to the pre-stored first correspondence relation is inconsistent with the slot number that is obtained according to the second correspondence relation.

6. The method for determining the slot of the field replaceable unit device as claimed in claim 4, wherein after the determining, according to the pre-stored first correspondence relation, the slot number corresponding to the peripheral component interconnect express cable number of the field replaceable unit device, the method for determining a slot of a field replaceable unit device further comprises:
controlling a prompt device to give a prompt on the slot number that is obtained according to the pre-stored first correspondence relation and the slot number that is obtained according to the second correspondence relation.

7. The method for determining the slot of the field replaceable unit device as claimed in claim 6, wherein the prompt device comprises a local prompt component and a remote prompt component.

8. The method for determining the slot of the field replaceable unit device as claimed in claim 4, further comprising:
receiving a configuration file of a first correspondence relation and/or a second correspondence relation corresponding to a specified type of computer device through a human-computer interaction apparatus; and
storing the configuration file in a nonvolatile storage unit.

9. The method for determining the slot of the field replaceable unit device as claimed in claim 8, further comprising:
modifying, according to a modification instruction received through the human-computer interaction apparatus, a correspondence relation in the configuration file specified.

10. The method for determining the slot of the field replaceable unit device as claimed in claim 2, wherein before locating, by invoking a slot location program corresponding to the bus protocol type, a slot of the field replaceable unit device that gives the fault alarm, the method further comprises:
integrating, with a slot location program of the peripheral component interconnect express bus, a slot location program corresponding to other bus protocol type other than the peripheral component interconnect express bus.

11. The method for determining the slot of the field replaceable unit device as claimed in claim 10, wherein a plurality of types of slot location programs corresponding to other bus protocol type are used.

12. The method for determining the slot of the field replaceable unit device as claimed in claim 1, wherein obtaining a model of a computer device and a peripheral component interconnect express cable number of a field replaceable unit device comprises one of the following:
obtaining the model of the computer device and the peripheral component interconnect express cable number of the field replaceable unit device by reading pre-stored data; and
making a request for the model of the computer device and the peripheral component interconnect express cable number of the field replaceable unit device by communicating with a target device.

13. The method for determining the slot of the field replaceable unit device as claimed in claim 1, wherein before the obtaining a pre-stored first correspondence relation between the peripheral component interconnect express cable number and a slot number, wherein the pre-stored first correspondence relation is a relation corresponding to the model of the computer device, the method further comprises:
storing first correspondence relations of various models of computer devices in same location.

14. The method for determining a slot of a field replaceable unit device as claimed in claim 1, wherein the peripheral component interconnect express cable number comprises a peripheral component interconnect express cable depth and a peripheral component interconnect express cable sub-number; and
determining, according to the pre-stored first correspondence relation, the slot number corresponding to the peripheral component interconnect express cable number of the field replaceable unit device comprises:
determining, according to the pre-stored first correspondence relation, a slot number corresponding to the peripheral component interconnect express cable sub-number under the peripheral component interconnect express cable depth.

15. The method for determining a slot of a field replaceable unit device as claimed in claim 14, wherein before determining, according to the pre-stored first correspondence relation, the slot number corresponding to the peripheral component interconnect express cable sub-number under the peripheral component interconnect express cable depth, the method further comprises:
establishing the pre-stored first correspondence relation among peripheral component interconnect express cable depths, peripheral component interconnect express cable sub-numbers and slot numbers of cable layers in response to that a plurality of peripheral component interconnect express cable layers are provided.

16. The method for determining the slot of the field replaceable unit device as claimed in claim 3, wherein after the determining the generation mode of the peripheral component interconnect express bus number bus device function number of the field replaceable unit device that gives the fault alarm, the method for determining the slot of the field replaceable unit device further comprises:
obtaining the model of the computer device, the peripheral component interconnect express cable number of the field replaceable unit device and the bus device function number of the field replaceable unit device in response to that a peripheral component interconnect express device topology of the computer device has a mixed structure of a preset slot and a self-defined cable, and a generation mode of a bus device function number of the preset slot is inconsistent with a generation mode of a bus device function number of a slot corresponding to the self-defined cable;
obtaining the pre-stored first correspondence relation and the second correspondence relation that are pre-stored and correspond to the model of the computer device; and
determining the slot number of the field replaceable unit device according to the pre-stored first correspondence relation, the second correspondence relation, the peripheral component interconnect express cable number of the field replaceable unit device and the bus device function number of the field replaceable unit device.

17. The method for determining the slot of the field replaceable unit device as claimed in claim 16, wherein determining the slot number of the field replaceable unit device according to the pre-stored first correspondence relation, the second correspondence relation, the peripheral component interconnect express cable number of the field replaceable unit device and the bus device function number of the field replaceable unit device comprises:
determining a correspondence relation and a number that correspond to the generation mode of the bus device function number of the preset slot from the pre-stored first correspondence relation, the second correspondence relation, the peripheral component interconnect express cable number of the field replaceable unit device and the bus device function number of the field replaceable unit device;
determining whether a slot corresponding to the number determined is found according to the correspondence relation determined; and
searching for a slot number corresponding to another undetermined number from another undetermined correspondence relation in response to that the slot is not found.

18. (canceled)

19. A device for determining a slot of a field replaceable unit device, comprising:
a memory configured to store a computer program; and
a processor configured to implement steps of the method for determining a slot of a field replaceable unit device in response to that executing the computer program, cause the processor to:
obtain a model of a computer device and a peripheral component interconnect express cable number of a field replaceable unit device in response to that the field replaceable unit device of a peripheral component interconnect express bus of the computer device gives a fault alarm:
obtain a pre-stored first correspondence relation between the peripheral component interconnect express cable number and a slot number, wherein the pre-stored first correspondence relation is a relation corresponding to the model of the computer device; and
determine, according to the pre-stored first correspondence relation, the slot number corresponding to the peripheral component interconnect express cable number of the field replaceable unit device.

20. A non-transitory computer-readable storage medium, storing a computer program, wherein the computer program implements steps of the method for determining a slot of a field replaceable unit device in response to that executed by a processor, cause the processor to:
obtain a model of a computer device and a peripheral component interconnect express cable number of a field replaceable unit device in response to that the field replaceable unit device of a peripheral component interconnect express bus of the computer device gives a fault alarm;
obtain a pre-stored first correspondence relation between the peripheral component interconnect express cable number and a slot number, wherein the pre-stored first correspondence relation is a relation corresponding to the model of the computer device; and
determine, according to the pre-stored first correspondence relation, the slot number corresponding to the peripheral component interconnect express cable number of the field replaceable unit device.

21. The method for determining a slot of a field replaceable unit device as claimed in claim 16, wherein a peripheral component interconnect express device topology of the computer device has a SWITCH card, self-defined cables and slots extend from the downstream of the SWITCH card.
